(19) United States
(12) Patent Application Publication
(10) Pub. No.: US 2014/0183417 A1
(43) Pub. Date: Jul. 3, 2014

(54) Carbon Nanotube Dispersion Containing Polyarylene Ether and Method for Preparing the Same

(71) Applicant: Cheil Industries Inc., Gumi-si (KR)

(72) Inventors: Yong Tae KIM, Uiwang-si (KR); Byeong Yeol KIM, Uiwang-si (KR); Hyun Hee KIM, Uiwang-si (KR); Won Jun CHOI, Uiwang-si (KR)

(73) Assignee: Cheil Industries Inc., Gumi-si (KR)

(21) Appl. No.: 13/896,429

(22) Filed: May 17, 2013

(30) Foreign Application Priority Data
Dec. 28, 2012 (KR) 10-2012-0157670

(51) Int. Cl. H01M 4/62; C08K 3/04; C08K 5/3415

(52) U.S. Cl. CPC H01M 4/625; C08K 5/3415; C08K 3/04
USPC 252/511; 524/104

(57) ABSTRACT

The carbon nanotube dispersion includes: carbon nanotubes; polyarylene ether having a number-average molecular weight of about 5,000 g/mol to about 25,000 g/mol; and a solvent, wherein the polyarylene ether may be non-covalently bonded to surfaces of the carbon nanotubes via π-π stacking interaction. The carbon nanotube dispersion is prepared by dispersing carbon nanotubes using inexpensive polyarylene ether.

### CROSS-REFERENCE TO RELATED APPLICATION

This application claims priority under 35 USC Section 119 to and the benefit of

Korean Patent Application 10-2012-0157670, filed Dec. 28, 2012, the entire disclosure of which is incorporated herein by reference.

### FIELD OF THE INVENTION

The present invention relates to a carbon nanotube dispersion including polyarylene ether and a method for preparing the same.

### BACKGROUND OF THE INVENTION

Carbon nanotubes are cylinders of graphite sheets and have a nanometer scale diameter and an sp² bond structure. Depending on the angle and structure of the carbon nanotube, carbon nanotubes can exhibit properties of metals or semiconductors. Further, depending on the bond order of carbon atoms which make up a wall of the carbon nanotube, carbon nanotubes can be classified as single-walled carbon nanotubes (SWCNTs), double-walled carbon nanotubes (DWCNTs), multi-walled carbon nanotubes (MWCNTs), and rope carbon nanotubes. Particularly, single-walled carbon nanotubes, having both metallic and semiconductor properties, exhibit various electrical, chemical, physical and optical properties, and smaller and more integrated devices can be manufactured based on these properties of the single-walled carbon nanotubes. Recent studies make it possible to apply carbon nanotubes to various fields including transparent electrodes, electrostatic dissipation films, field emission devices, plate heating elements, optoelectronic devices, various sensors, transistors, and the like.

However, despite the usefulness of carbon nanotubes, there is a limit in application of carbon nanotubes due to low solubility and low dispersibility. That is, carbon nanotubes undergo strong Van der Waals attraction therebetween, causing agglomeration instead of uniform dispersion.

To solve this problem, studies have been made to achieve functionalization of carbon nanotubes through surface modification. One example of such studies is non-covalent functionalization of carbon nanotubes.

Non-covalent functionalization of carbon nanotubes is designed to impart desired functions to carbon nanotubes by bonding modification materials to surfaces of the carbon nanotubes via non-covalent bonding such as hydrogen bonding, Van der Waals bonding, charge transfer, dipole-dipole interaction, π-π stacking interaction, etc. Since non-covalent functionalization does not require formation of defects on carbon nanotubes, it can provide functional groups to the carbon nanotubes without deteriorating the properties thereof Generally, non-covalent functionalization is performed using surfactants, aromatic hydrocarbons, biomaterials, and the like, and in most cases, enables stable dispersion of the carbon nanotubes in an aqueous solution.

A method using aromatic hydrocarbons has been most extensively studied for non-covalent functionalization of carbon nanotubes. Walls of the carbon nanotubes include a hexagonal graphite structure and can interact with molecules consisting of aromatic hydrocarbons such as conjugated polymers via π-π stacking interaction.

Conjugated polymers having an aromatic ring in a polymer chain interact with the walls of the carbon nanotubes via π-π stacking interaction and functionalize the carbon nanotubes by encasing the same. Examples of conjugated polymers include poly(metaphenylene-vinylene) (PmPV), poly(phenylene-ethynylene) (PPE), poly {(2,6-pyridinylene-vinylene)-co-[(2,5-dioctyloxy-p-phenylene)vinylene]} (PPvPV), poly(methyl methacrylate) (PMMA), poly(5-alkoxy-m-phenylene-vinylene) (PAmPV), poly(p-phenylene-vinylene) (PPV), cisoidal PPA (polyphenylacetylene), transoidal PPA, and the like.

However, since the conjugated polymers used for dispersion of carbon nanotubes (method for non-covalent functionalization) are expensive, there is a need for development of a method of dispersing carbon nanotubes using inexpensive polymers.

### SUMMARY OF THE INVENTION

The present invention provides a carbon nanotube dispersion including polyarylene ether, which can allow uniform dispersion of carbon nanotubes in a solvent without phase separation and at low cost via non-covalent functionalization of the carbon nanotubes, and to a method for preparing the same.

The carbon nanotube dispersion includes carbon nanotubes, polyarylene ether having a number-average molecular weight of about 5,000 g/mol to about 25,000 g/mol, and a solvent.

In one embodiment, the polyarylene ether may be non-covalently bonded to surfaces of the carbon nanotubes via π-π stacking interaction.

In one embodiment, the polyarylene ether may have a number-average molecular weight of about 10,000 g/mol to about 20,000 g/mol.

In one embodiment, the polyarylene ether may include a unit represented by Formula 1:

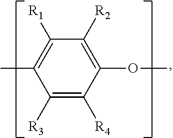

wherein R₁, R₂, R₃ and R₄ are the same or different and are each independently hydrogen, halogen, C₁-C₆ alkyl, or C₆-C₁₂ aryl.

In one embodiment, the carbon nanotubes and the polyarylene ether (total solute) may be present in an amount of about 1% by weight (wt %) to about 15 wt %; the solvent may be present in an amount of about 85 wt % to about 99 wt %; the carbon nanotubes may be present in an amount of about 80 wt % to about 99.5 wt % in the total solute; and the polyarylene ether may be in present an amount of about 0.5 wt % to about 20 wt % in the total solute.

In one embodiment, the carbon nanotube dispersion may have a UV-visible permeability of about 10% to about 40%.

In one embodiment, the solvent may be an organic solvent including a nitrogen (N) atom having a non-covalent electron pair.

The present invention further relates to a method for preparing the carbon nanotube dispersion. The method includes dispersing carbon nanotubes by mixing the carbon nanotubes with polyarylene ether having a number-average molecular weight of about 5,000 g/mol to about 25,000 g/mol.

In one embodiment, the polyarylene ether may be non-covalently bonded to surfaces of the carbon nanotubes via π-π stacking interaction.

In one embodiment, the polyarylene ether may have a number-average molecular weight of about 10,000 g/mol to about 20,000 g/mol.

In one embodiment, the polyarylene ether may include a unit represented by Formula 1:

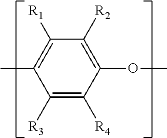

wherein R₁, R₂, R₃ and R₄ are the same or different and are each independently hydrogen, halogen, C₁-C₆ alkyl, or C₆-C₁₂ aryl.

In one embodiment, the carbon nanotubes and the polyarylene ether (total solute) may be present in an amount of about 1% by weight (wt %) to about 15 wt %; the solvent may be present in an amount of about 85 wt % to about 99 wt %; the carbon nanotubes may be present in an amount of about 80 wt % to about 99.5 wt % in the total solute; and the polyarylene ether may be present in an amount of about 0.5 wt % to about 20 wt % in the total solute.

In one embodiment, the carbon nanotubes may include at least one of single-walled carbon nanotubes, double-walled carbon nanotubes, multi-walled carbon nanotubes, and rope carbon nanotubes. In one embodiment, the solvent may be an organic solvent including a nitrogen (N) atom having a non-covalent electron pair.

The present invention further relates to an electrode. The electrode is prepared using the carbon nanotube dispersion.

### BRIEF DESCRIPTION OF DRAWINGS

FIG. 1 is a picture of a carbon nanotube dispersion prepared in Example 3 after leaving the same for 24 hours.

FIG. 2 is a picture of a carbon nanotube dispersion prepared in Comparative Example 1 after leaving the same for 24 hours.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

In accordance with one embodiment of the invention, a carbon nanotube dispersion includes (A) carbon nanotubes, (B) polyarylene ether having a number-average molecular weight of about 5,000 g/mol to about 25,000 g/mol, and (C) a solvent. The polyarylene ether (B) may be non-covalently bonded to surfaces of the carbon nanotubes via π-π stacking interaction.

(A) Carbon Nanotubes

Carbon nanotubes (A) may be conventional carbon nanotubes. Carbon nanotubes (A) may include single-walled carbon nanotubes, double-walled carbon nanotubes, multi-walled carbon nanotubes, rope carbon nanotubes, or a combination thereof.

The carbon nanotube dispersion may include the carbon nanotubes (A) in an amount of about 80 wt % to about 99.5 wt % based on the total amount of solute (the carbon nanotubes (A) and the polyarylene ether (B)), for example about 90 wt % to about 99 wt % based on the total amount of solute. In some embodiments, the carbon nanotube dispersion may include the carbon nanotubes in an amount of about 80, 81, 82, 83, 84, 85, 86, 87, 88, 89, 90, 91, 92, 93, 94, 95, 96, 97, 98, 99, 99.1, 99.2, 99.3, 99.4, or 99.5 wt %. Further, according to some embodiments of the present invention, the amount of the carbon nanotubes can be in a range from about any of the foregoing amounts to about any other of the foregoing amounts. Within this range, the carbon nanotubes can be uniformly dispersed even at high concentrations without phase separation.

(B) Polyarylene ether having a number-average molecular weight of about 5,000 g/mol to about 25,000 g/mol

The polyarylene ether (B) may be non-covalently bonded to surfaces of the carbon nanotubes (non-covalent functionalization) via π-π stacking interaction. The polyarylene ether (B) has a number-average molecular weight of about 5,000 g/mol to about 25,000 g/mol, for example from about 10,000 g/mol to about 20,000 g/mol. If the number-average molecular weight of the polyarylene ether (B) is less than about 5,000 g/mol, non-covalent functionalization of the carbon nanotubes may be insufficient, causing no dispersion of the carbon nanotubes. If the number-average molecular weight of the polyarylene ether (B) exceeds about 25,000 g/mol, dispersibility of the carbon nanotubes can be lowered.

In one embodiment, the polyarylene ether (B) may be a polymer having a number-average molecular weight of about 5,000 g/mol to about 25,000 g/mol and including a unit represented by Formula 1:

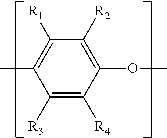

wherein R₁, R₂, R₃ and R₄ are the same or different and are each independently hydrogen, halogen, C₁-C₆ alkyl, or C₆-C₁₂ aryl.

Examples of the polyarylene ether (B) may include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, copolymers of poly(2,6-dimethyl-1,4-phenylene)ether and poly(2,3,6-trimethyl-1,4-phenylene)ether, copolymers of poly(2,6-dimethyl-1,4-phenylene)ether and poly(2,3,5-triethyl-1,4-phenylene)ether, and the like, and combinations thereof, all of which have a number-average molecular weight ranging from about 5,000 g/mol to about 25,000 g/mol.

Any commercially available polyarylene ether may be used as the polyarylene ether (B). For example, the polyarylene ether may be prepared by reacting mono-hydroxyl aromatic compounds at about 10° C. to about 50° C. in the presence of a dissolving agent, an organic solvent, a catalyst, and oxygen. As used herein, the dissolving agent may be toluene or anisole, and the organic solvent may be at least one selected from the group consisting of C1-C6 alkyl alcohols and mixtures thereof. Further, the catalyst may include copper salts and/or amine compounds. The polyarylene ether prepared by this method may have a number-average molecular weight of about 5,000 g/mol to about 25,000 g/mol, and may include the dissolving agent in an amount of about 1 ppm to about 3,000 ppm, the organic solvent in an amount of about 1 ppm to about 3,000 ppm, and the catalyst in an amount of about 1 ppm to about 1,000 ppm.

The carbon nanotube dispersion may include the polyarylene ether in an amount of about 0.5 wt % to about 20 wt % based on the total amount of solute (the carbon nanotubes (A) and the polyarylene ether (B)), for example about 1 wt % to about 10 wt % based on the total amount of solute. In some embodiments, the carbon nanotube dispersion may include the polyarylene ether in an amount of about 0.5, 0.6, 0.7, 0.8, 0.9, 1, 2, 3, 4, 5, 6, 7, 8, 9, 10, 11, 12, 13, 14, 15, 16, 17, 18, 19, or 20 wt %. Further, according to some embodiments of the present invention, the amount of the polyarylene ether can be in a range from about any of the foregoing amounts to about any other of the foregoing amounts.

Within this range, the polyarylene ether can non-covalently functionalize the carbon nanotubes, and can allow uniform dispersion of the carbon nanotubes without phase separation.

(C) Solvent

Any organic solvent used for dispersion of carbon nanotubes may be used as the solvent (C) without limitation. For example, an organic solvent including a nitrogen (N) atom having a non-covalent electron pair, such as N-methylpyrrolidone (NMP), pyridine, morpholine, dimethylaminobenzene, diethylaminobenzene, n-butylamine, and the like, and combinations thereof, may be used. In exemplary embodiments, N-methylpyrrolidone (NMP) may be used.

In one embodiment, the carbon nanotube dispersion may include the total solute (the carbon nanotubes (A) and the polyarylene ether (B)) in an amount of about 1 wt % to about 15 wt %, and the solvent (C) may be present in an amount of about 85 wt % to about 99 wt %.

In some embodiments, the carbon nanotube dispersion may include the total solute in an amount of about 1, 2, 3, 4, 5, 6, 7, 8, 9, 10, 11, 12, 13, 14, or 15 wt % based on the total weight of the carbon nanotube dispersion. Further, according to some embodiments of the present invention, the total amount of solute can be in a range from about any of the foregoing amounts to about any other of the foregoing amounts.

In some embodiments, the carbon nanotube dispersion may include the solvent in an amount of about 85, 86, 87, 88, 89, 90, 91, 92, 93, 94, 95, 96, 97, 98, or 99 wt % based on the total weight of the carbon nanotube dispersion. Further, according to some embodiments of the present invention, the amount of the solvent can be in a range from about any of the foregoing amounts to about any other of the foregoing amounts.

Within these ranges, it is possible to obtain a carbon nanotube dispersion which includes carbon nanotubes uniformly dispersed therein without phase separation.

In one embodiment, the carbon nanotube dispersion may have a UV-visible permeability of about 10% to about 40%, for example about 15% to about 38%, as measured using a UV-visible spectrometer. Within this range, it is possible to obtain a carbon nanotube dispersion which includes carbon nanotubes uniformly dispersed therein without phase separation.

The invention also relates to a method for preparing the carbon nanotube dispersion. The method includes: dispersing carbon nanotubes (A) by mixing the carbon nanotubes (A) with polyarylene ether (B) having a number-average molecular weight of about 5,000 g/mol to about 25,000 g/mol in a solvent (C), wherein, upon mixing, the polyarylene ether (B) is non-covalently bonded to surfaces of the carbon nanotubes (A) via π-π stacking interaction.

In this method, mixing may be performed by a typical mixing method (dispersion method) such as ultrasonic treatment, milling, and the like. Although a mixing duration is not particularly limited, mixing may be performed, for example, for about 10 minutes to about 3 hours.

The invention further relates to an electrode. The electrode may be prepared using the carbon nanotube dispersion. For example, the carbon nanotube dispersion may be included as an additive in a cathode active material for secondary batteries. In one embodiment, after uniformly mixing the carbon nanotube dispersion with a cathode active material for secondary batteries, an electrode may be prepared by any typical method known in the art.

Now, the present invention will be described in more detail with reference to some examples. However, it should be noted that these examples are provided for illustration only and are not to be construed in any way as limiting the present invention.

A description of details apparent to those skilled in the art will be omitted for clarity.

### EXAMPLES

### Examples 1-4 and Comparative Examples 1-2

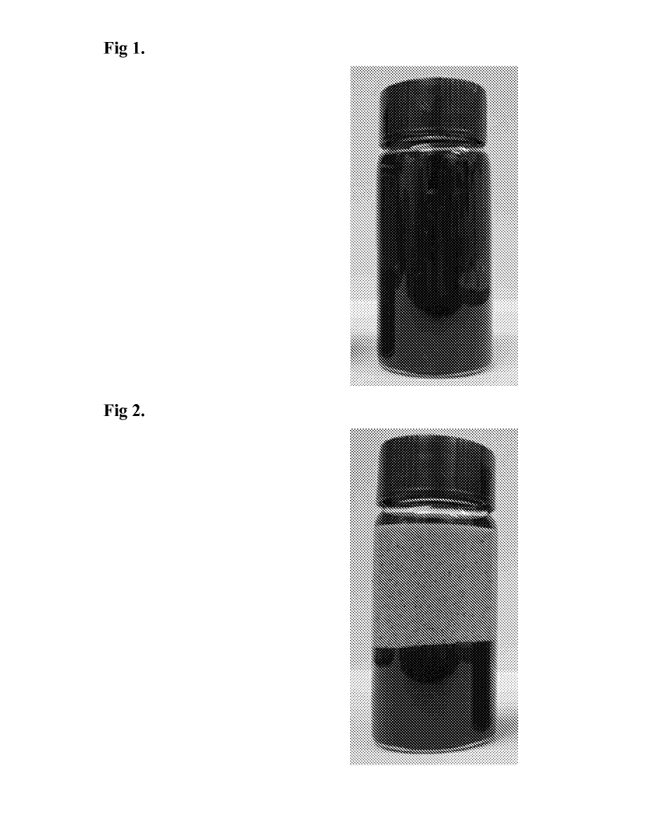

According to each composition in the following Table 1, after placing carbon nanotubes (Flo tube 9000 manufactured by CNANO Company), polyarylene ether (poly(2,6-dimethyl-1,4-phenylene)ether oxide) having a number-average molecular weight as listed in Table 1, and N-methylpyrrolidone (NMP) in a 30 ml container, carbon nanotube dispersions are prepared by mixing (dispersing) the components for 30 minutes using a sonicator. Each of the carbon nanotube dispersions prepared in Example 3 and Comparative example 1 is left at room temperature for 24 hours and then photographed. The pictures of the solutions are shown in FIGS. 1 and 2.

TABLE 1

| | | | | | Comparative | |
|---|---|---|---|---|---|---|
| | Example | | | | Example | |
| | 1 | 2 | 3 | 4 | 1 | 2 |
| Amount of carbon nanotubes (g) | 4.5 | 4.5 | 4.7 | 4.5 | 5 | 4.5 |
| Number-average molecular weight | 5,000 | 14,000 | 14,000 | 20,000 | — | 50,000 |
| (g/mol) | | | | | | |
| Amount of polyarylene ether (g) | 0.5 | 0.5 | 0.3 | 0.5 | — | 0.5 |
| Amount of NMP (g) | 95 | 95 | 95 | 95 | 95 | 95 |
| Dispersibility evaluation | ◯ | ◯ | ◯ | ◯ | X | X |
| UV-visible permeability (%) | 24 | 18 | 20 | 32 | 84 | 77 |

Property Evaluation

1. Dispersibility: After leaving the prepared carbon nanotube dispersion at room temperature for 24 hours, the solution is observed with the naked eye to evaluate dispersibility. A sample exhibiting excellent dispersibility without phase separation is evaluated as O and a sample exhibiting phase separation was evaluated as X.

2. UV-visible permeability (%): After diluting the prepared carbon nanotube solution 2,000 folds in an NMP solvent, the diluted solution is subjected to centrifugation at 3,000 rpm for 30 minutes. Then, the UV-visible permeability of the solution is obtained by measuring the UV-visible spectrum of the supernatant at a wavelength of 550 nm using a UV-visible spectrometer. The UV-visible permeability of the carbon nanotube dispersion decreases with increasing dispersibility of carbon nanotubes.

From the results, the carbon nanotube dispersions (Examples 1-4), which are prepared using polyarylene ether having a number-average molecular weight of about 5,000 g/mol to about 25,000 g/mol, are determined to exhibit stable dispersibility after being left for 24 hours and had a low UV-visible permeability even after centrifugation at 3,000 rpm. Thus, it could be seen that the carbon nanotube dispersions prepared in the inventive examples had high dispersibility.

In contrast, when the polyarylene ether is not used (Comparative Example 1) or when the polyarylene ether has an undesirable number-average molecular weight (Comparative Example 2), the carbon nanotube dispersions underwent phase separation and have a high UV-visible permeability. Thus, it can be seen that the carbon nanotube dispersions of the comparative examples have significantly reduced dispersibility as compared with the dispersibility of the solutions of the inventive examples.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A carbon nanotube dispersion comprising:
carbon nanotubes;
polyarylene ether having a number-average molecular weight of about 5,000 g/mol to about 25,000 g/mol; and
a solvent.

2. The carbon nanotube dispersion according to claim 1, wherein the polyarylene ether is non-covalently bonded to surfaces of the carbon nanotubes via π-π stacking interaction.

3. The carbon nanotube dispersion according to claim 1, wherein the polyarylene ether has a number-average molecular weight of about 10,000 g/mol to about 20,000 g/mol.

4. The carbon nanotube dispersion according to claim 1, wherein the polyarylene ether comprises a unit represented by Formula 1: 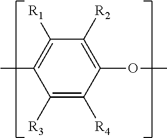
wherein R₁, R₂, R₃ and R₄ are the same or different and are each independently hydrogen, halogen, C₁-C₆ alkyl, or C₆-C₁₂ aryl.

5. The carbon nanotube dispersion according to claim 1, wherein the carbon nanotubes and the polyarylene ether (total solute) are present in an amount of about 1 wt % to about 15 wt % based on the total weight of the carbon nanotube dispersion, the solvent is present in an amount of about 85 wt % to about 99 wt % based on the total weight of the carbon nanotube dispersion, the carbon nanotubes are present in an amount of about 80 wt % to about 99.5 wt % based on the total amount of solute, and the polyarylene ether is present in an amount of about 0.5 wt % to about 20 wt % based on the total amount of solute.

6. The carbon nanotube dispersion according to claim 1, wherein the carbon nanotube dispersion has a UV-visible permeability of about 10% to about 40%.

7. The carbon nanotube dispersion according to claim 1, wherein the solvent is an organic solvent comprising a nitrogen (N) atom having a non-covalent electron pair.

8. A method for preparing a carbon nanotube dispersion, comprising: dispersing carbon nanotubes by mixing the carbon nanotubes with polyarylene ether having a number-average molecular weight of about 5,000 g/mol to about 25,000 g/mol in a solvent.

9. The method according to claim 8, wherein the polyarylene ether is non-covalently bonded to surfaces of the carbon nanotubes via π-π stacking interaction.

10. The method according to claim 8, wherein the polyarylene ether has a number-average molecular weight of about 10,000 g/mol to about 20,000 g/mol.

11. The method according to claim 8, wherein the polyarylene ether comprises a unit represented by Formula 1: 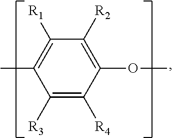
wherein R₁, R₂, R₃ and R₄ are the same or different and are each independently hydrogen, halogen, C₁-C₆ alkyl, or C₆-C₁₂ aryl.

12. The method according to claim 8, wherein the carbon nanotubes and the polyarylene ether (total solute) are present in an amount of about 1 wt % to about 15 wt % based on the total weight of the carbon nanotube dispersion, the solvent is present in an amount of about 85 wt % to about 99 wt % based on the total weight of the carbon nanotube dispersion, the carbon nanotubes are present in an amount of about 80 wt % to about 99.5 wt % based on the total amount of solute, and the polyarylene ether is present in an amount of about 0.5 wt % to about 20 wt % based on the total amount of solute.

13. The method according to claim 8, wherein the carbon nanotubes comprise single-walled carbon nanotubes, double-walled carbon nanotubes, multi-walled carbon nanotubes, rope carbon nanotube, or a combination thereof.

14. The method according to claim 8, wherein the solvent is an organic solvent comprising a nitrogen (N) atom having a non-covalent electron pair.

15. An electrode prepared using the carbon nanotube dispersion according to claim 1.
